(19) United States
(12) Patent Application Publication
(10) Pub. No.: US 2023/0115916 A1
(43) Pub. Date: Apr. 13, 2023

(54) PARKING ASSISTANCE APPARATUS, PARKING ASSISTANCE METHOD, AND NON-TRANSITORY TANGIBLE STORAGE MEDIUM STORING PARKING ASSISTANCE PROGRAM

(71) Applicant: DENSO CORPORATION, Kariya-city (JP)

(72) Inventors: Takamasa HIDAKA, Kariya-city (JP); Koudai YAMAURA, Kariya-city (JP); Masatake WADA, Kariya-city (JP)

(21) Appl. No.: 18/080,298

(22) Filed: Dec. 13, 2022

Related U.S. Application Data
(63) Continuation of application No. PCT/JP2021/029523, filed on Aug. 10, 2021.

(30) Foreign Application Priority Data
Aug. 21, 2020 (JP) 2020-140188

(51) Int. Cl. B60W 30/06; G08G 1/14

(52) U.S. Cl. CPC B60W 30/06; G08G 1/148

(57) ABSTRACT

By a parking assistance apparatus, a parking assistance system, or a non-transitory tangible storage medium storing a parking assistance program executed by a computer, an obstructing vehicle is identified when an exit request for an exit vehicle is received, a movement load of the obstructing vehicle is determined, a non-obstruction position is determined as a target parking position, the obstructing vehicle is moved to the non-obstruction position, and the exit vehicle is moved along the guidance route.

### CROSS REFERENCE TO RELATED APPLICATIONS

The present application is a continuation application of International Patent Application No. PCT/JP2021/029523 filed on Aug. 10, 2021, which designated the U.S. and claims the benefit of priority from Japanese Patent Application No. 2020-140188 filed on Aug. 21, 2020. The entire disclosures of all of the above applications are incorporated herein by reference.

### TECHNICAL FIELD

The present disclosure relates to a parking assistance apparatus, a parking assistance method, and a non-transitory tangible storage medium storing a parking assistance program that are configured to assist in parking of a vehicle.

### BACKGROUND

For example, in a comparative example, there is an automated valet parking technology as a parking assistance system including a parking assistance apparatus.

### SUMMARY

By a parking assistance apparatus, a parking assistance system, or a non-transitory tangible storage medium storing a parking assistance program executed by a computer, an obstructing vehicle is identified when an exit request for an exit vehicle is received, a movement load of the obstructing vehicle is determined, a non-obstruction position is determined as a target parking position, the obstructing vehicle is moved to the non-obstruction position, and the exit vehicle is moved along the guidance route.

### BRIEF DESCRIPTION OF THE DRAWINGS

FIG. 1 is a plan diagram showing one example of a parking lot.

FIG. 2 is a block diagram showing a configuration of a parking assistance system.

FIG. 3 is a functional block diagram of a controller of a management apparatus.

FIG. 4 is a flowchart of a movement management process executed by the management apparatus.

FIG. 5 is a flowchart of a movement setting process of the movement management process.

FIG. 6 is an explanatory diagram showing one example of a priority table.

FIG. 7 is an explanatory diagram showing one example of parking space information.

FIG. 8 is an explanatory diagram showing one example of a section identification situation.

FIG. 9 is a flowchart of an obstructing vehicle identification process.

FIG. 10 is an explanatory diagram showing a non-obstruction area in the parking lot.

FIG. 11 is an explanatory diagram showing a correspondence relationship between movement loads and movement destination areas.

### DETAILED DESCRIPTION

In an automated valet parking technology, for example, a management apparatus for a parking lot guides an autonomous vehicle from an alighting area to a parking position of a parking area. By the way, in an automated valet parking lot, in order to increase a parking density, there are cases where multiple autonomous vehicles are parked longitudinally or horizontally adjacent to each other. As a result of a detailed study of the inventors, it has been found that, in such a manner, the same vehicle may be frequently moved for a vehicle attempting to exit, so that the load of the frequently moved vehicle increases.

According to one example embodiment of the present disclosure, a parking assistance apparatus, a parking assistance method, and a non-transitory tangible storage medium storing a parking assistance program assist in vehicle parking, and are able to prevent the same vehicle from being frequently moved for an exit of a vehicle different from the same vehicle.

One example of the present disclosure is a parking assistance apparatus that assists in automated valet parking of a vehicle. In the parking lot, multiple vehicles capable of performing autonomous driving according to a guidance route set by the parking assistance apparatus are set to multiple autonomous driving vehicles. Among the multiple autonomous driving vehicles, a vehicle moving for the exit is referred to as an exit vehicle. Further, a vehicle obstructing a movement of the exit vehicle is referred to as an obstructing vehicle.

The parking assistance apparatus includes the load determination unit, the movement destination setting unit, and the movement control unit. The load determination unit identifies the obstructing vehicle and determines the movement load of the obstructing vehicle upon receiving an exit request for causing the exit vehicle to exit. The movement load represents a magnitude of a load caused by a movement for the exit vehicle during parking. The exit vehicle may be also referred to as a particular exit vehicle.

The movement destination setting unit sets a non-obstruction position for the obstructing vehicle as a target parking position according to the movement load, wherein the obstructing vehicle is unlikely to obstruct an other exit vehicle different from the particular exit vehicle when the obstructing vehicle is parked at the non-obstruction position.

According to such a configuration, the obstructing vehicle is moved to the non-obstruction position. Therefore, if the other exit vehicle moves, it may be possible to prevent the obstructing vehicle from moving again. Accordingly, it may be possible to prevent the same vehicle from frequently being moved.

Further, according to one example embodiment of the present disclosure, the load determination unit may identify the obstructing vehicle for each direction in which the particular exit vehicle is movable. The parking assistance apparatus may further include a movement determination unit and a movement selection unit.

The movement determination unit may determine whether, in a case where the obstructing vehicles is moved for each direction where the particular exit vehicle is able to move, the particular exit vehicle is able to move. In a case where there are multiple directions in which the exit vehicle is able to move if the obstructing vehicles are moved, the movement selection unit may select the obstructing vehicle positioned in a direction with the smaller movement load of the obstructing vehicle among the directions in which the particular exit vehicle is able to move.

The movement destination setting unit may set a movement destination of the selected obstructing vehicle. The movement control unit may move the selected obstructing vehicles to the movement destinations, and moves the particular exit vehicle along the guidance route.

According to such a configuration, it is possible to cause the obstructing vehicle with the bigger parking load to be less likely to move, since only the obstructing vehicle positioned in the movement direction with the smaller parking load is moved when there are multiple directions in which the particular exit vehicle is able to move. Accordingly, it may be possible to prevent the same vehicle from frequently being moved.

Hereinafter, an embodiment of the present disclosure will be described with reference to the drawings.

### 1. EMBODIMENT

[1-1. Configuration of Parking Assistance System]

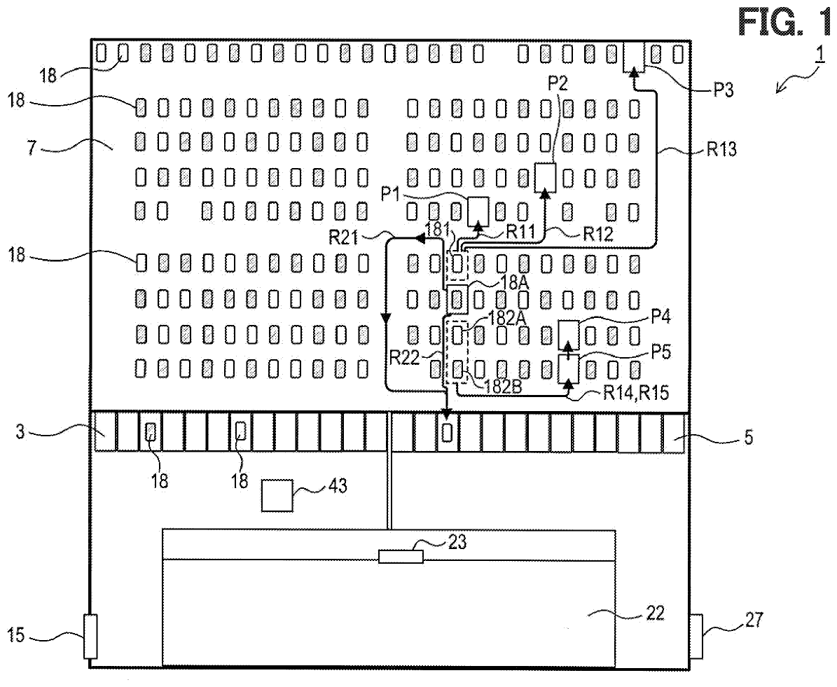

A configuration of a parking assistance system 1 will be described with reference to FIGS. 1 to 3. As shown in FIG. 1, the parking assistance system 1 includes an entrance room 3 set in an alighting area where the user alights from the vehicle, and an exit room 5 set in a boarding area where the user boards on the vehicle, and a parking area 7. In the following description, an area including the entrance room 3, the exit room 5, and the parking area 7 is referred to as a parking lot. Each of the entrance room 3 and the exit rooms 5 includes a parking section. The entrance room 3 is connected to an outside area of the parking assistance system 1 through an entrance 15. An autonomous driving vehicle 18 is able to enter the entrance room 3 of the parking lot through the entrance 15 from the outside. The autonomous driving vehicle 18 has an automated valet parking function.

It should be noted that the autonomous driving vehicle 18 needs to be able to only carry out the automated valet parking function in the parking lot, and does not need to have an autonomous driving function outside the parking lot. Further, the automated valet parking function includes a function of traveling from the entrance room 3 to the target parking position of the parking area 7 and parking by autonomous driving. The automatic valet parking function also includes a function of traveling from the parking position of the parking area 7 to the exit room 5 to exit.

The automated valet parking function particularly includes a function of repeatedly acquiring position information about the autonomous driving vehicle 18 and transmitting the position information to a management apparatus 39 corresponding to the parking assistance apparatus of the present disclosure, and a function of receiving a guidance route from the management apparatus 39, controlling the autonomous driving vehicle 18 according to the guidance route, and traveling. The position information of the autonomous driving vehicle 18 indicates an estimation result of the current position of the autonomous driving vehicle 18, and includes, for example, coordinates within an area of the parking lot. In the drawings, the term of “information” may be also referred to as “INFO”.

The entrance room 3 and the exit room 5 may be adjacent to an entrance 23 of a facility 22, such as a store. The occupant of the autonomous driving vehicle 18, who has entered the entrance room 3, gets off the autonomous driving vehicle 18. Then, the occupant is able to walk to the entrance 23.

The exit room 5 is connected to the outside area of the parking assistance system 1 through an exit 27. The autonomous driving vehicle 18 is able to move from the exit room 5 to the outside of the parking assistance system 1 through the exit 27. The exit room 5 is adjacent to the entrance 23. The occupant is able to walk from the entrance 23 to the exit room 5.

The parking area 7 is an area where multiple autonomous driving vehicles 18 are able to be parked. Multiple parking sections are provided inside the parking area 7. Each section of the entrance rooms 3, the exit rooms 5, and the parking area 7 is an area where one autonomous driving vehicle 18 is able to be parked. However, the parking area 7 does not need to be sectioned.

The autonomous driving vehicle 18 is able to travel from the entrance room 3 to the parking area 7. Further, the autonomous driving vehicle 18 is able to travel from the parking area 7 to the exit room 5.

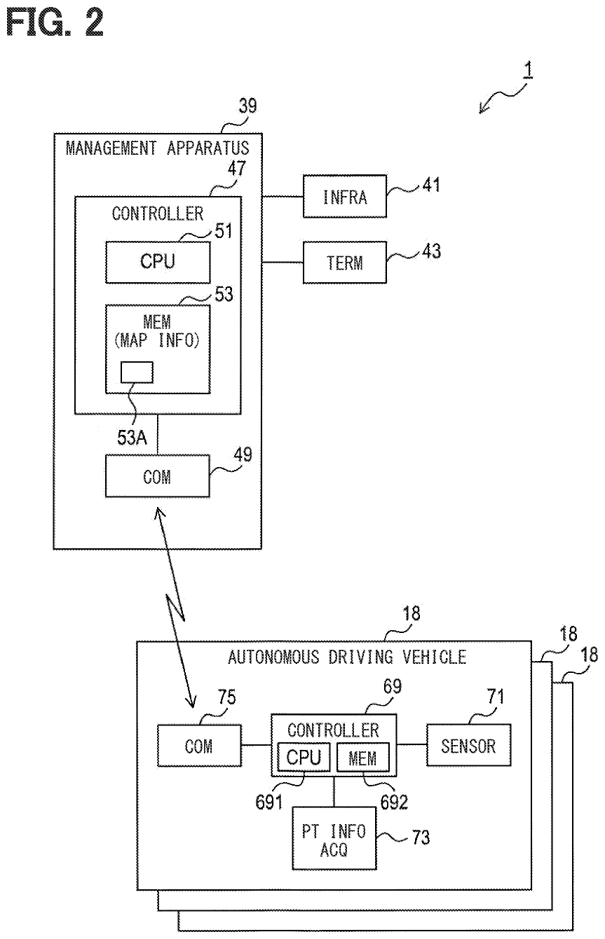

As shown in FIG. 2, the parking assistance system 1 includes the management apparatus 39, an infrastructure 41, and a terminal device 43. In the drawings, the infrastructure 41 may be also referred to as “INFRA”, and the terminal device 43 may be also referred to as “TERM”.

The management apparatus 39 includes a controller 47 and a communication unit 49. The controller 47 includes a microcomputer having a CPU 51 and a semiconductor memory (hereinafter referred to as a memory 53) such as a RAM or a ROM, for example. The management apparatus 39 is able to manage multiple autonomous driving vehicles 18. In the drawings, the communication unit 49 may be also referred to as “COM”, and the memory 53 may be also referred to as “MEM”.

The CPU 51 executes a program stored in a non-transitory tangible storage medium to perform functions to be provided by the controller 47. The program includes a parking assistance program of the present disclosure. In this example, the memory 53 corresponds to a non-transitory tangible storage medium storing the program. When the program is executed, a method corresponding to the program is executed. The controller 47 may include one or more microcomputers.

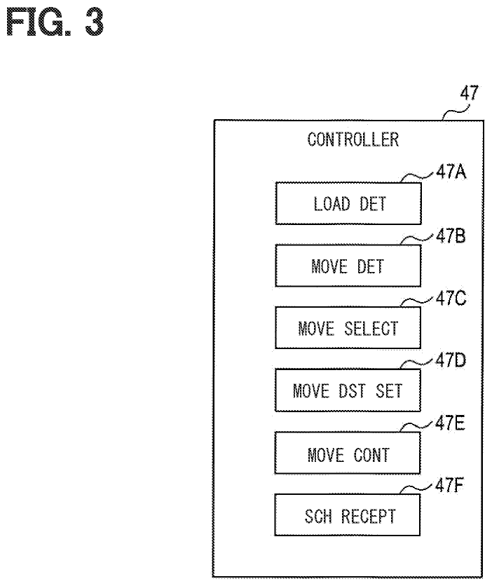

The controller 47 includes a configuration for transmitting a guidance route to a parking position, a parking start instruction, and an exit start instruction, to the autonomous driving vehicle 18. For example, as shown in FIG. 3, the controller 47 includes a load determination unit 47A, a movement determination unit 47B, a movement selection unit 47C, a movement destination setting unit 47D, a movement control unit 47E, and a scheduling reception unit 47F. The management apparatus 39 corresponds to a guidance calculation unit, a guidance setting unit, and a re-calculation unit of the present disclosure. Operations of each units 47A to 47F constituting the controller 47 will be described later. In the drawings, the load determination unit 47A may be also referred to as “LOAD DET”, the movement determination unit 47B may be also referred to as “MOVE DET”, the movement selection unit 47C may be also referred to as “MOVE SELECT”, the movement destination setting unit 47D may be also referred to as “MOVE DEST SET”, the movement control unit 47E may be also referred to as “MOVE CONT”, and the scheduling reception unit 47F may be also referred to as “SCH RECEPT”.

The memory 53 stores map information of the parking lot. The map information includes information indicating a state of each parking section included in the parking area 7. The state of the parking section may be an available state where the parking section is vacant (hereinafter referred to as a vacant state) and an unavailable state where the parking section is occupied by the autonomous driving vehicle 18 (hereinafter referred to as an occupied state). The communication unit 49 is able to communicate with the autonomous driving vehicle 18.

The memory 53 stores parking space information for associating information (hereinafter, also referred to as adjacent section information) for identifying a parking space (hereinafter, also referred to as a parking section) of the parking lot and an adjacent parking area with vehicle identification information and managing those information. The vehicle identification information is information for identifying a vehicle parked in the parking space, and is information based on, for example, VIN, a frame number, a number plate, or the like. The VIN indicates a vehicle identification number.

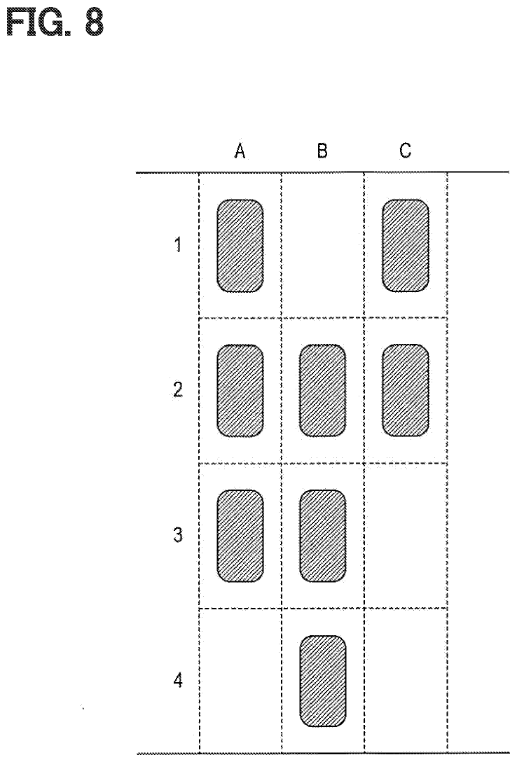

FIG. 7 illustrates parking space information. The parking space information may be divided into multiple databases, and may include elements not described in FIG. 7. FIG. 8 is a diagram showing a parking lot state corresponding to the parking space information.

In the parking space information, section identification information (also referred to as parking space ID) for identifying each section in the parking lot and the adjacent section information (also referred to as obstructing parking space ID) are registered in advance. The section identification information and the adjacent section information are set in advance, based on the arrangement of parking sections in the parking lot. The adjacent section is also called as an obstructing parking space, and is another parking section adjacent to the parking section. That is, the adjacent section is a parking section through which the autonomous driving vehicle 18 parked in the certain section must pass in order to enter the aisle. In the drawings, the section identification information may be also referred to as “SEC DENT INFO”, the adjacent section information may be also referred to as “AD SEC INFO”, and the vehicle identification information may be also referred to as “VE DENT INFO”.

The adjacent section will be described with reference to FIG. 7 and FIG. 8. In an example of FIG. 8, a parking section is represented as, for example, a section A1 with use of columns and rows. As long as the parking sections in the parking lot are able to be identified, the section identification information may be serial numbers, random numbers, position coordinates, or the like.

In FIG. 8, sections A1, B1, and C1 face the aisle. Therefore, the autonomous driving vehicle 18 parked in the section A1, the section B1, or the section C1 is able to enter the aisle without being obstructed by a different autonomous driving vehicle 18. Therefore, for the sections A1, B1, and C1, the columns of “adjacent section information” in the parking space information are set to a state of “non-applicable”. Similarly, since sections A4, B4, and C4 face the aisle, the columns of the “adjacent section information” are set to the state of “non-applicable”.

On the other hand, a section A2 is sandwiched by the section A1 and a section A3. When the management apparatus 39 guides the autonomous driving vehicle 18 parked in the section A2 to the aisle, the management apparatus 39 needs to determine whether the different autonomous driving vehicle 18 is parked in the section A1. Further, when the management apparatus 39 guides the autonomous driving vehicle 18 parked in the section A2 to the aisle, the management apparatus 39 needs to determine whether the different autonomous driving vehicle 18 is parked in the section A3. Therefore, A1 and A3 are described in the column of the adjacent section information of the section A2 in parking space information. In the example of FIG. 8, the autonomous driving vehicle 18 is parked in the section A2. Therefore, vehicle identification information indicating the autonomous driving vehicle 18 parked in the section A2 is recorded in the column of A2 of the parking space information.

Further, the memory 53 stores a priority table 53A. The priority table 53A will be detailed later.

The infrastructure 41 has a function of acquiring information representing the state inside the parking assistance system 1 (hereinafter referred to as parking lot information) and a function of providing the parking lot information to the management apparatus 39. The infrastructure 41 includes a camera, a LiDAR, and the like that capture the inside of the parking lot. The infrastructure 41 may detect position information of the autonomous driving vehicle 18 inside the parking lot. In this case, the management apparatus 39 may use both the position information of the autonomous driving vehicle 18 detected by the autonomous driving vehicle 18 and the position information detected by the infrastructure 41, or may use any of these position information.

For example, examples of the parking lot information include information representing positions of obstacles, information representing the status of each parking section in the parking area 7, position information about autonomous driving vehicles 18 positioned inside the parking assistance system 1, and the like.

As shown in FIG. 1, the terminal device 43 is installed in the vicinity of the entrance room 3. The terminal device 43 outputs a movement request signal in response to a movement request that is an input operation indicating user's resolve to move the autonomous driving vehicle 18. The movement request includes a parking request to guide the autonomous driving vehicle 18 in the entrance room 3 to the parking area 7 and to request parking, and an exit request to guide the autonomous driving vehicle 18 parked in the parking area 7 to the exit room 5 and to request exit. Further, the movement request signal is a signal requesting parking or exit.

The terminal device 43 may output, to the management apparatus 39, identification information of the autonomous driving vehicle 18 and the like together with the signal output in response to the input operation. Further, the terminal device 43 outputs the movement request signal in accordance with the input operation indicating the user's resolve to move the autonomous driving vehicle 18.

As described above, the autonomous driving vehicle 18 has the automated valet parking function. As shown in FIG. 2, the autonomous driving vehicle 18 includes a controller 69, a sensor group 71, a position information acquisition unit 73, and a communication unit 75. In the drawings, the sensor group 71 may be also referred to as “SENSOR”, the position information acquisition unit 73 may be also referred to as “PT INFO ACQ”, and the communication unit 75 may be also referred to as “COM”.

The controller 69 includes a microcomputer having a CPU 691 and a semiconductor memory (hereinafter referred to as a memory 692) such as a RAM or a ROM, for example. The controller 69 controls each operation of the autonomous driving vehicle 18. The function of the autonomous driving is implemented by the control of the controller 69. The autonomous driving vehicle 18 acquires, from the management apparatus 39, the map information of the parking lot and the guidance route. When performing the autonomous driving, the autonomous driving vehicle 18 uses the acquired map information and the guidance route. In the drawings, the memory 692 may be also referred to as “MEM”.

The sensor group 71 acquires peripheral information indicating a situation around the autonomous driving vehicle 18. The contents of the peripheral information include, for example, a position of an obstacle existing around the autonomous driving vehicle 18 and the like. The sensor group 71 may include, for example, a camera, a LiDAR, and the like. The autonomous driving vehicle 18 uses the peripheral information when performing the autonomous driving.

The position information acquisition unit 73 acquires the position information of the autonomous driving vehicle 18. The position information acquisition unit 73 is, for example, a position estimation system using the LiDAR and a map. The autonomous driving vehicle 18 uses the position information when performing autonomous driving. The communication unit 75 is able to communicate with the management apparatus 39.

[1-2. Process]

[1-2-1. Movement Management Process Executed by Management Apparatus]

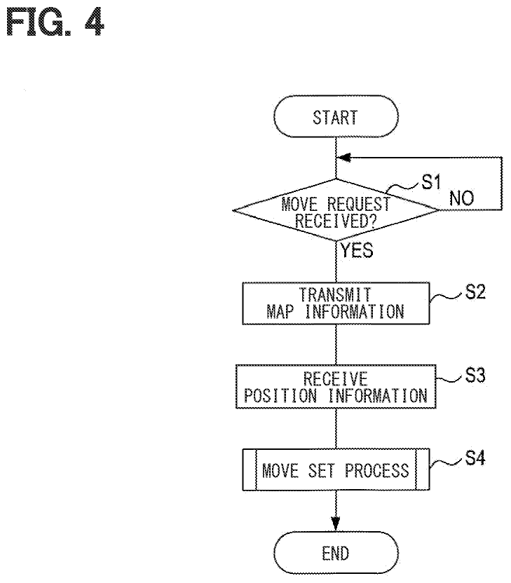

The movement management process executed by the management apparatus 39 will be described with reference to FIG. 4. The movement management process starts in response to, for example, the power of the management apparatus 39 being turned on. After that, the process is repeatedly executed. The process after S2 may be executed for each autonomous driving vehicle 18 corresponding to the movement request. Further, when an obstructing vehicle is selected, the guidance route is set for the selected obstructing vehicle as well. Further, hereinafter, it is also described that the process executed by the controller 47 (particularly, CPU 51) of the management apparatus 39 is executed by the management apparatus 39.

In S1 of the movement management process shown in FIG. 4, the management apparatus 39 determines whether to receive the movement request signal. When the movement request signal is not received, the process repeats S1. When the movement request signal is received, the process shifts to S2.

When a user such as an occupant of the autonomous driving vehicle 18 operates the terminal device 43 to input the movement request, the terminal device 43 transmits a movement request signal corresponding to this input to the management apparatus 39. At this time, the user inputs vehicle information such as number plate information for identifying the vehicle, user information such as a user ID and a password for identifying the user, and other necessary information to the terminal device 43.

When the terminal device 43 is operated, predetermined information such as the identification ID for identifying the terminal device 43, vehicle information, user information, and the like may be transmitted to the management apparatus 39. After inputting the movement request, the user is able to leave the parking lot and head for a destination.

Next, the management apparatus 39 transmits the map information of the parking lot to the autonomous driving vehicle 18 in S2. That is, when the user inputs the movement request with the terminal device 43, the management apparatus 39 transmits map information about the parking lot to the autonomous driving vehicle 18. However, when the map information of the parking lot has already been recorded in the autonomous driving vehicle 18, such when the exit is requested, the process in S2 may be omitted. In this case, the request of the position information may be given to the autonomous driving vehicle 18.

The autonomous driving vehicle 18 that has received the map information is set so as to return the position information and the vehicle state, as described later. Thus, the management apparatus 39 receives the position information transmitted from the autonomous driving vehicle 18 in S3.

Next, in S4, the management apparatus 39 executes a movement setting process. In the movement setting process, the management apparatus 39 generates a guidance route that does not overlap with a guidance route set for the different autonomous driving vehicle 18. The management apparatus 39 guides the autonomous driving vehicle 18 to the parking position or the exit position. When the movement setting process ends, the management apparatus 39 ends the movement management process.

[1-2-2. Movement Setting Process]

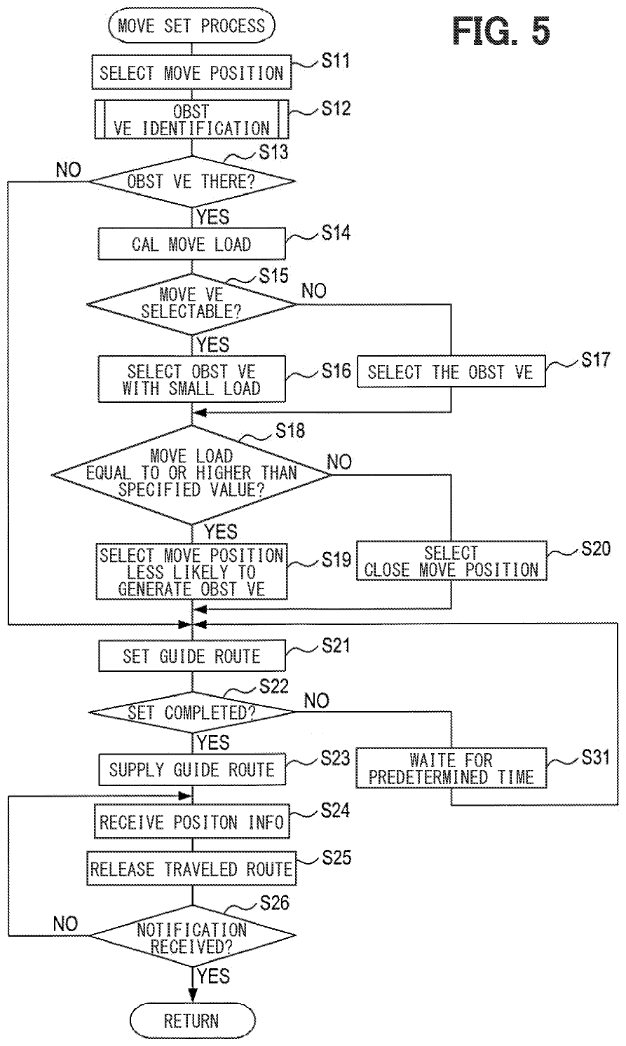

The movement setting process executed by the management apparatus 39 will be described with reference to FIG. 5. In the movement setting process, first, in S11, the management apparatus 39 selects a target position, here, a parking position or an exit position. That is, when the movement request input from the terminal device 43 is the parking request, the parking position is selected. When the movement request input from the terminal device 43 is the exit request, the exit position is selected.

In the parking area 7, a vacant parking section is selected as the parking position. In the exit room 5, a vacant parking section may be selected as the exit position. For example, the management apparatus 39 determines the state of each parking section as follows. When the autonomous driving vehicle 18 starts parking in a certain parking section, the autonomous driving vehicle 18 sends the identification information of the parking section, parking start information, and vehicle identification information to the management apparatus 39. Further, when the autonomous driving vehicle 18 exits from the parking section in which the vehicle has been parked, the autonomous driving vehicle 18 sends the identification information of the parking section and parking end information to the management apparatus 39.

When receiving the above information from the autonomous driving vehicle 18, the management apparatus 39 updates the map information of the parking lot and the parking space information, those information being recorded in the memory 53.

The management apparatus 39 determines the state of each parking section based on the history of the information transmitted from autonomous driving vehicle 18. Furthermore, the management apparatus 39 may determine the state of each parking section based on the information supplied by the infrastructure 41. For example, vacant sections may be identified by capturing the parking area 7 with the camera of the infrastructure 41. Alternatively, by installing a sensor of the infrastructure 41 in each parking section of the parking area 7, it may be determined whether the section is vacant based on the information from the sensor.

When there is only one vacant parking space, the management apparatus 39 sets the vacant parking space as the parking position. When there are multiple vacant parking sections, the management apparatus 39 selects one parking section as the parking position from the multiple vacant parking sections based on a predetermined criterion. Examples of the criteria include selecting the parking space closest to the entrance room 3, selecting the parking space closest to the exit room 5, and selecting the parking section in an area including relatively large number of vacant parking sections.

Next, in S12, the load determination unit 47A of the management apparatus 39 executes an obstructing vehicle identification process for identifying an obstructing vehicle. Here, among multiple autonomous driving vehicles 18, a vehicle that moves for the exit, that is, a vehicle that moves from the parking area 7 to the boarding area is referred to as an exit vehicle 18A, as shown in FIG. 1. The obstructing vehicle is an autonomous driving vehicle 18 that is parked, and is a vehicle that obstructs the movement of the exit vehicle 18A. That is, the obstructing vehicle is a vehicle positioned between the exit vehicle 18A and the aisle. If the obstructing vehicle moves, the exit vehicle 18A is able to enter the aisle.

The load determination unit 47A identifies the obstructing vehicle for each direction where the exit vehicle 18A is able to move. In the present embodiment, the load determination unit 47A identifies the obstructing vehicles 181 and 182 positioned in a section from the current position of the exit vehicle 18A to the aisle in each of the forward and backward directions of the exit vehicle 18A. For example, the direction where the exit vehicle 18A is able to move includes a direction where the exit vehicle 18A moves forward and a direction where the exit vehicle 18A moves backward.

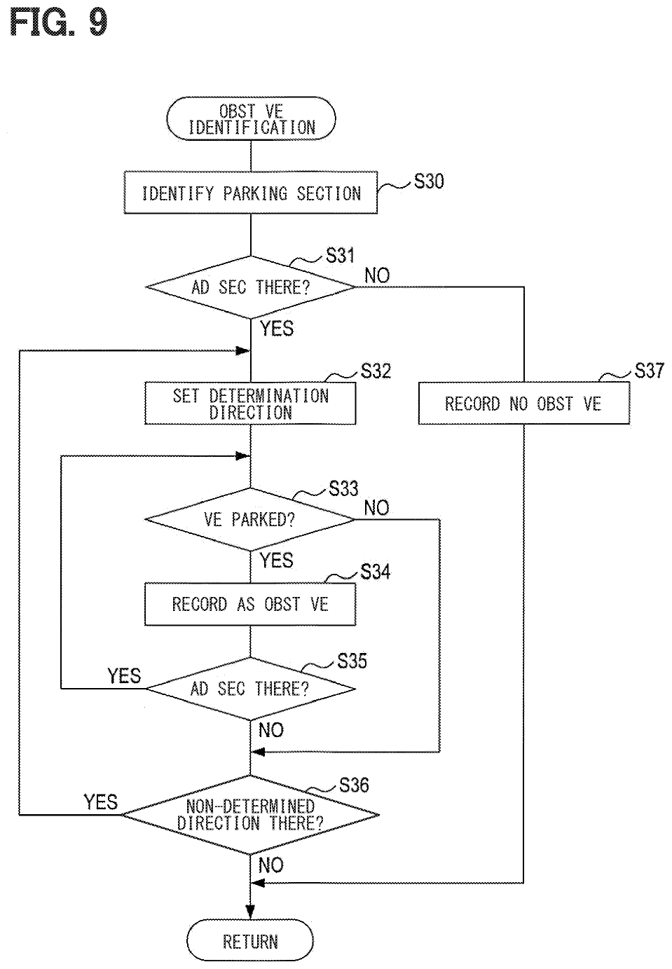

The load determination unit 47A executes the obstructing vehicle identification process as follow, for example. A method for extracting the obstructing vehicles 181 and 182 will be described with reference to FIG. 9.

In the obstructing vehicle identification process, first, in S30, the load determination unit 47A refers to the parking space information, and identifies the parking section of the exit vehicle 18A based on the vehicle identification information of the exit vehicle 18A. For example, the vehicle identification information is transmitted to management apparatus 39 together with an exit instruction.

Next, in S31, the load determination unit 47A refers to the adjacent section information of the parking space information, and determines whether there is a section adjacent to a section where the exit vehicle 18A is parked. When the adjacent section information is set to the state of “non-applicable” in S31, the determination in S31 is negative, and the process shifts to S37. When the adjacent section information is set to the state of “non-applicable”, the section where the exit vehicle 18A is parked directly faces the aisle. There is no section where the different autonomous driving vehicles 18 that become the obstructing vehicles 181 and 182 or the obstructing vehicles 181 and 182 are parked. In S37, when the load determination unit 47A determines that there is no obstructing vehicle, and records, in the memory 53, that there is no obstructing vehicle. After that, the process ends, and shifts to S13 of FIG. 5.

On the other hand, in S31, when the section identification information is set in the adjacent section information, determination in S31 is performed, and the process shifts to S32. In S32, the load determination unit 47A determines a determination direction for the exit vehicle 18A. The load determination unit 47A establishes the determination direction in order to identify the obstructing vehicles 181 and 182 positioned in the section from the current position of the exit vehicle to the aisle for each direction in which the exit vehicle 18A is able to move, that is, the forward and backward directions of the exit vehicle 18A. For example, a forward direction may be preferentially selected. Thereby, in S33 to S35, it is determined whether there is the obstructing vehicle in the direction established in S32.

Next, in S33, the load determination unit 47A refers to a section designated by the adjacent section information. The load determination unit 47A reads the vehicle identification information, and determines whether the autonomous driving vehicle 18 is parked in the designated parking section. In S33, when the autonomous driving vehicle 18 is not parked in the section targeted for the determination, the process shifts to S36. In S33, when the autonomous driving vehicle 18 is parked in the section targeted for the determination, the process shifts to S34.

In S34, the load determination unit 47A records, as the obstructing vehicle 181 or 182, the autonomous driving vehicles 18 parked in the section targeted for the determination in the memory 53.

Next, in S35, the load determination unit 47A refers to the adjacent section information of the parking space information, and determines whether there is a parking section adjacent to the parked section targeted for the determination. When the adjacent section information is set to the state of “non-applicable” in S35, the process shifts to S36. In S35, when the section identification information is set in the adjacent section information, the process shifts to S33.

In S36, the load determination unit 47A determines whether there is a direction where identification of the obstructing vehicles 181 and 182 has not yet been performed among the directions where the exit vehicle 18A is able to move. When there is the undetermined direction, the process shifts to S32. In this case, in S32, a movement direction that is the undetermined direction of S36 is set to the determination direction. In S36, when the obstructing vehicles 181 and 182 have already been identified in the forward and backward directions of the exit vehicle 18A, the process ends and shifts to S13 in FIG. 5.

As in the parking area 7 of the present embodiment, when the four vehicles are parked in parallel between the aisles, vehicles blocking both of the forward and backward directions, which are advancing directions of the exit vehicle 18A, are identified as the obstructing vehicles 181 and 182. For example, in an example shown in FIG. 1, among the four vehicles parked in parallel, a course of the exit vehicle 18A not facing the aisle is blocked by one obstructing vehicle 181 on the deep side (in other words, positioned far from the entrance room 3 as compared with the obstructing vehicle 182) of the parking lot and two obstructing vehicles 182A and 182B on the front side (in other words, positioned closer to the entrance room 3). The obstructing vehicles 182A and 182B may be collectively referred to as the obstructing vehicle 182 as well.

The parallel parking is a state in which multiple vehicles are parked in a longitudinal direction of the vehicles. Although the example in FIG. 1 shows a configuration in which four vehicles are parked in parallel between the aisles, a configuration in which three or more vehicles are parked in parallel may cause the obstructing vehicle.

Next, in S13, the load determination unit 47A determines whether the obstructing vehicles 181 and 182 are identified. When the obstructing vehicles 181 and 182 are not identified, the exit vehicle 18A is able to move immediately. Therefore, the process skips S14 to S20, and shifts to S21. When the obstructing vehicles 181 and 182 are identified, the process shifts to S14.

Next, in S14, the load determination unit 47A of the management apparatus 39 calculates movement loads for all the extracted obstructing vehicles 181 and 182. The movement load represents the magnitude of the load on the obstructing vehicles 181 and 182 due to the movement of the obstructing vehicles 181 and 182 for the exit vehicle 18A during parking. The movement load may include the concept of load as consumption energy, the concept of load as the effect on the mechanism of the vehicle, and the like. In the drawings, the movement load may be also referred to as “MOVE LOAD”.

The load determination unit 47A determines, as the movement load, at least one of an accumulated energy consumption, fuel efficiency of each of the obstructing vehicles 181 and 182, the degree of handling of each of the obstructing vehicles 181 and 182, the degree of accuracy of the automatic driving by the obstructing vehicles 181 and 182, the number of times an internal combustion engine starts, or a time until an exit scheduled time. Further, the load determination unit 47A determines whether the obstructing vehicles 181 and 182 are electric vehicles.

The accumulated energy consumption represents the amount of energy used for moving the parked vehicle. The accumulated energy consumption corresponds to, for example, power consumption, fuel consumption, and the like. The number of times the internal combustion engine starts represents the number of times the internal combustion engine starts after the obstructing vehicles 181 and 182 are parked in the parking area 7. In a case of a vehicle such as an electric vehicle that does not have the internal combustion engine, the number of starts is zero. The accumulated energy consumption and the number of times the internal combustion engine starts are recorded in the memory 53 each time they increase.

For example, the load determination unit 47A reads the amount of consumed energy, the number of starts, and the like from the memory 53, and obtains the movement load based on the read values. The details of a process for obtaining the movement load will be described later.

The exit scheduled time is received by the scheduling reception unit 47F. The scheduling reception unit 47F receives the exit scheduled time input from a user wishing the exit of the autonomous driving vehicle 18 via the terminal device 43, a mobile terminal possessed by the user, or the like.

When the autonomous driving vehicle 18 enters the parking lot, the autonomous driving vehicle 18 transmits most of information regarding the movement load to the management apparatus 39. Thereby, the management apparatus 39 is able to mostly recognize the movement load of each autonomous driving vehicle 18.

When receiving the information regarding the movement load, the management apparatus 39 writes on a priority table 53A based on this information. It should be noted that the management apparatus 39 writes the accumulated energy consumption and the number of times the internal combustion engine starts in any area of the memory 53.

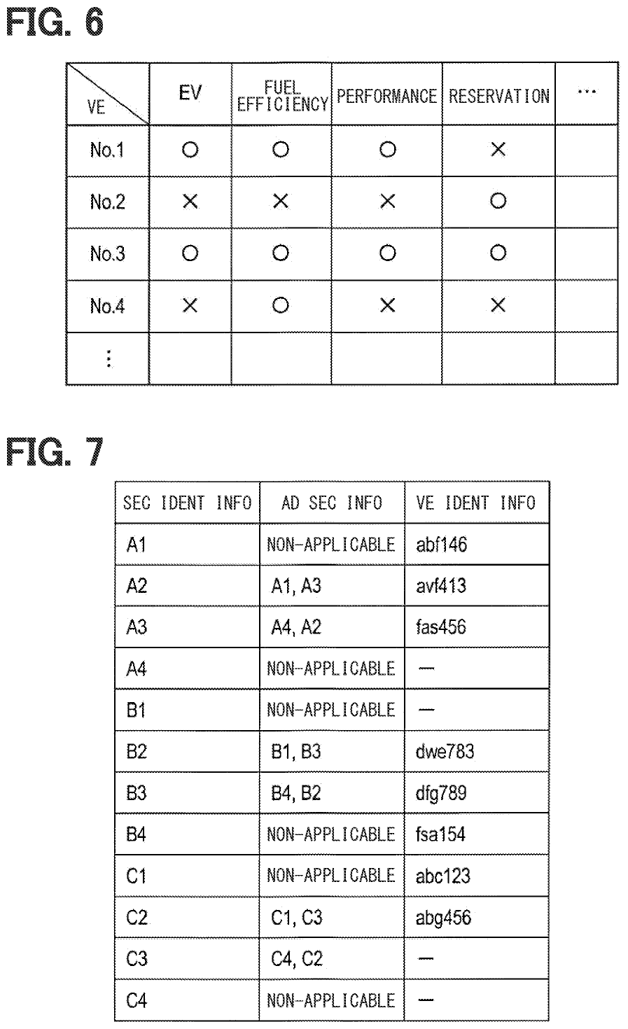

The priority table 53A is, for example, as shown in FIG. 6, a table in which categories of multiple items are associated with each vehicle. The priority table 53A is mainly used for selecting the obstructing vehicles 181 and 182 to be moved or used for being less likely or select the obstructing vehicles 181 and 182. In the drawings, the term of “vehicle” may be also referred to as “VE”.

For example, in the priority table 53A, for each autonomous driving vehicle 18 in the parking area 7, whether the autonomous driving vehicle 18 is the electric vehicle (that is, EV), whether the fuel efficiency is equal to or higher than a preset reference value, a vehicle performance is equal to or higher than a preset reference value, the time until the exit scheduled time is equal to or higher than a preset reference time, and the like are associated. In the priority table 53A shown in FIG. 6, a circle mark is given when the condition for each item is satisfied, and a cross mark is given when the conditions are not satisfied.

More specifically, in the priority table 53A, the circle mark is given when the autonomous vehicle 18 is the electric vehicle, and the cross mark is given when the autonomous vehicle 18 is not the electric vehicle. The circle mark is given when the fuel efficiency is equal to or higher than the reference value, and the cross mark is given when the fuel efficiency is less than the reference value. The circle mark is given when the vehicle performance is equal to or higher than the reference value, and the cross mark is given when the vehicle performance is less than the reference value. The circle mark is given when the time until the exit scheduled time is equal to or higher than the reference time, and the cross mark is given when the time until the exit scheduled time is less than the reference time.

Here, the load determination unit 47A calculates the movement load by combining the amount of consumed energy, the number of starts, or the like with each item of the priority table 53A. The details of a process for obtaining the movement load will be described later.

Next, in S15, the movement determination unit 47B of the management apparatus 39 determines whether the move vehicle is selectable. In other words, the movement determination unit 47B of the management apparatus 39 determines whether there are multiple options for the advancing direction of the exit vehicle 18A. In this process, the movement determination unit 47B determines whether, in a case where either of the obstructing vehicles 181 and 182 is moved for each direction where the exit vehicle 18A is movable, the exit vehicle 18A is movable. The case where “either of the obstructing vehicles 181 and 182 is moved” means a case where the exit vehicle 18A is movable even when only the obstructing vehicle 181 is moved, and also a case where the exit vehicle 18A is movable even when only the obstructing vehicle 182 is moved.

In the case of FIG. 1, the exit vehicle 18A is able to exit by selectively moving one obstructing vehicle 181 or two obstructing vehicles 182A and 182B. In the case of the present embodiment, four vehicles are parked in parallel between the aisles. The determination in S15 is positive since the exit vehicle 18A is able to enter the aisle from either the front or the rear. However, in a case where there is no aisle in front of or in rear of four vehicles parked in parallel, such as a case where there is a wall, a cliff, or the like, the determination is negative since the vehicle is not movable in a direction where there is no aisle. In other words, the determination by the movement determination unit 47B of the management apparatus 39 is negative when the number of options of the advancing direction of the exit vehicle 18A is one.

When, in S15, the management apparatus 39 determines that the movement vehicle is able to be selected from among multiple obstructing vehicles 181 and 182, the process shifts to S16. The movement selection unit 47C selects the obstructing vehicle 181 or the obstructing vehicle 182 so as to reduce the movement load in the movement direction. As the movement direction in which the movement load is reduced, for example, an obstructing vehicle of which movement load is smaller is selected as the movement vehicle from among the obstructing vehicle 181 and the obstructing vehicle 182.

Specifically, the movement selection unit 47C scores, for example, movement load, and selects, as the vehicle to be moved, the obstructing vehicle with low scores from the obstructing vehicles 181 and 182. In this case, a weighted average value of the accumulated energy consumption and the number of times the internal combustion engine starts may be obtained from the movement load. As the vehicle to be moved, a vehicle in a direction with the smaller value may be selected from the obstructing vehicles 181 and 182.

That is, it is preferable that the movement selection unit 47C is more likely to select, from among the obstructing vehicles 181 and 182, the obstructing vehicle of which the number of times the internal combustion engine starts is less than the preset reference (for example the electric vehicle). In particular, when one obstructing vehicle 181 is selected or two obstructing vehicles 182A and 182B are selected, it is preferable that a movement load of one obstructing vehicle 181 and the sum or the average of movement loads of two obstructing vehicles 182A and 182B are compared for selecting the vehicle.

However, the movement selection unit 47C refers to the priority table 53A. For example, the movement selection unit 47C reduces the above scores according to the number of items with the circle mark, and increases the above scores according to the number of items marked with the cross mark. That is, it is made difficult to select the obstructing vehicle whose fuel efficiency is less than the preset value from among the obstructing vehicles 181 and 182. Further, the movement selection unit 47C is more likely to select, from among the obstructing vehicles 181 and 182, the obstructing vehicle whose handling of the vehicle is equal to or higher than the preset reference or automatic driving accuracy is equal to or higher than the preset reference.

On the other hand, when the management apparatus 39 determines that the movement vehicle is not able to be selected from the multiple obstructing vehicles 181 and 182 in S15, the process shifts to S17. Further, the management apparatus 39 selects all of those obstructing vehicles 181 and 182 as the obstructing vehicles 181 and 182 to be moved.

Next, in S18, the movement destination setting unit 47D of the management apparatus 39 determines whether each of the movement loads of the obstructing vehicles 181 and 182 selected as the movement vehicle is equal to or higher than a preset specified value.

Here, in the parking area 7, each parking space is associated with the degree of obstruction of the movement of the exit vehicle 18A. For example, parking spaces P1 and P5 shown in FIG. 1 face the aisle, and also are parking spaces with possibility that vehicles parked in the P1 and P5 become the obstructing vehicles for two vehicles among three vehicles parked in the same row. Further, for example, parking spaces P2 and P4 shown in FIG. 1 do not face the aisle, and also are parking spaces with possibility that vehicles parked in the P2 and P4 become the obstructing vehicles for one vehicle among three vehicles parked in the same row. Furthermore, for example, although a parking space P3 shown in FIG. 1 faces the aisle, there is, in the same row, no vehicle parked in parallel. Therefore, the parking space P3 is a parking space with no possibility of becoming the obstructing vehicle.

In consideration of these, each parking space in the parking area 7 is classified in advance, in the order of P3, P2 and P4, P1 and P5, as a place where it is difficult to obstruct the movement of the different exit vehicle (also referred to as the other exit vehicle), in other words, a place with a low possibility that the vehicle is moved. The P3, P2, and P4 are non-obstruction positions set in advance as places in which vehicles are less likely to obstruct the movement of the different exit vehicle.

For example, the management apparatus 39 stores, in the memory 53, area information regarding each parking space (hereinafter, also referred to as section) in the parking area 7, the area information indicating that the degree of obstruction of the movement of the difficult exit vehicle is classified.

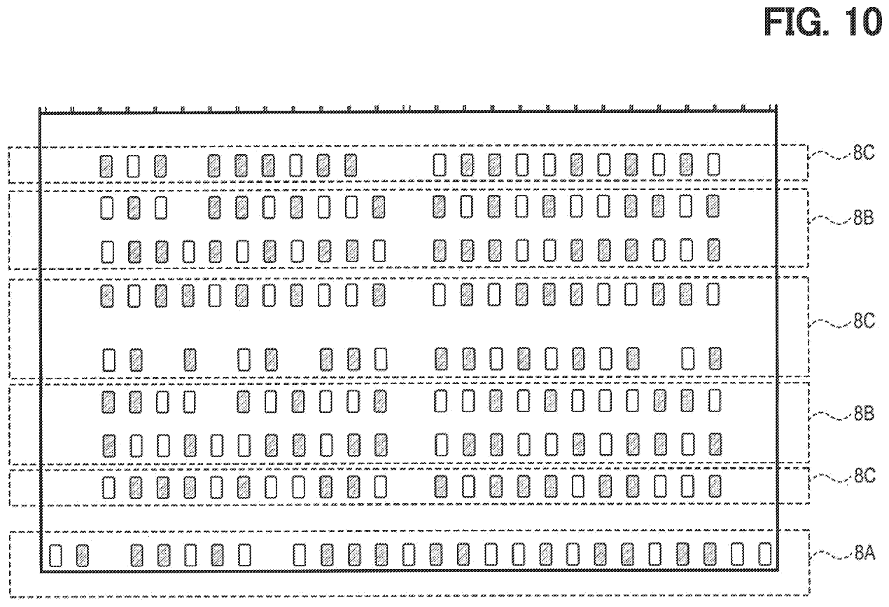

FIG. 10 shows a place where the movement of the different exit vehicle is less likely to be obstructed, and exemplifies non-obstruction areas set in the parking area 7. In FIG. 10, in the parking area 7, a first non-obstruction area 8A, a second non-obstruction area 8B, and a third non-obstruction area 8C are set. Regarding the rank of non-obstruction positions, the first non-obstruction area 8A has the highest rank. That is, in the parking area 7, the non-obstruction area 8A is an area where it is the least likely to obstruct the movement of the different exit vehicle. The rank of non-obstruction positions becomes lower in the order of first non-obstruction area 8A, second non-obstruction area 8B, and third non-obstruction area 8C.

The first non-obstruction area 8A includes the P3 of FIG. 1, and also is a parking space where vehicles are not parked in parallel. The second non-obstruction area 8B includes the P2 and the P4 of FIG. 1, is a parking space where three or more vehicles are parked in parallel, and does not face the aisle. The third non-obstruction area 8C includes the P1 and the P5 of FIG. 1, is a parking space where three or more vehicles are parked in parallel, and faces the aisle.

In one example, the ranks of non-obstruction positions are set in advance according to a layout of multiple sections in the parking area 7.

Like P3 in FIG. 1, a parking space, which faces the aisle and vehicles are not parked in parallel in, is the least likely to obstruct the movement of the different exit vehicle. That is, the parked space like P3 has the highest rank as the non-obstruction position.

When three or more vehicles are parked in parallel, parking spaces, (corresponding to P2 and P4) which do not face the aisle, have the lowest possibility of obstructing the movement of the exit vehicle next to the above parking space. When three or more vehicles are parked in parallel, it is assumed that parking spaces (P1, P5) facing the aisle have the highest possibility of obstructing the movement of the different exit vehicle. The parking spaces have the lowest rank of the non-obstruction positions.

In multiple parking spaces in the parking area 7, four or more vehicles may be parked in parallel. In this case, it may be set such that the farther the position is from the aisle in forward and backward directions of the vehicle, the lower the possibility of obstructing the movement of the different exit vehicle is. In other words, when sections of the parking area 7 are set so that four or more vehicles are able to be parked, the greater the number of sections sandwiched by a section and the aisle is, the lower the possibility of obstructing the movement of the different vehicle is.

In a case where, in S18, the movement load of the vehicle selected as the movement vehicle between the obstructing vehicle 181 and the obstructing vehicles 182 is equal to or higher than the specified value, in S19, the movement destination setting unit 47D sets the movement position at which the vehicle is unlikely to become the obstructing vehicle for the different vehicle when a vehicle different from the exit vehicle 18A is about to exit. The movement position is a movement destination position of the obstructing vehicle 181 or 182 selected as the movement vehicle.

In other words, the movement destination setting unit 47D sets the non-obstruction position as the movement destination of the non-obstructing vehicle 181 or 182 as the movement load of the non-obstructing vehicle 181 or 182 increases. For example, the movement destination setting unit 47D sets the non-obstruction position to the movement destination when the above-described score is equal to or higher than a first threshold. When the movement position is not able to be set to the non-obstruction position, the movement destination setting unit 47D may set a movement position where the vehicle is less likely to be the obstructing vehicle as much as possible.

On the other hand, when the movement load of the obstructing vehicle 181 or 182 selected as the movement vehicle is less than the preset specified value in S18, the movement destination setting unit 47D sets the movement position to a position that is different from the non-obstruction position and is close to a current position of the movement vehicle in S20.

However, the movement destination setting unit 47D sets the movement destination that becomes closer to the exit location as an exit scheduled time for the obstructing vehicle 181 or 182 is closer to a current time.

The processes in S12 to S17 are processes for identifying and identifying the obstructing vehicle 181 or 182 that becomes an obstacle if the autonomous driving vehicle 18 according to the movement request moves. The processes in S18 to S20 are processes for setting the movement destination (hereinafter, also referred to as movement position) for the identified obstructing vehicle 181 or 182 based on the movement load.

Next, in S21, the management apparatus 39 sets the guidance route using the map information of the parking lot. Here, the management apparatus 39 sets a route from the current position of the autonomous driving vehicle 18 to the parking position selected in S11. The route is a guidance route for the autonomous driving vehicle 18 to perform the autonomous driving. Further, when there is the obstructing vehicle in S13, the guidance route to the parking position selected in S19 for the obstructing vehicle 181 or 182 is set.

For example, when the P1 is set to the movement destination for the obstructing vehicle 181, the management apparatus 39 sets a guidance route R11. When the P2 is set to the movement destination, the management apparatus 39 sets a guidance route R12. When the P3 is set to the movement destination, the management apparatus 39 sets a guidance route R13. Further, when the P4 or P5 is set to the movement destination for the obstructing vehicle 182, the management apparatus 39 sets a guidance route R14 or R15. the guidance route for the obstructing vehicle 181 or the guidance route for the obstructing vehicle 182 is selected based on the determination results of S15 to S17 in order to set the guidance route.

However, when attempting to set the guidance route for the obstructing vehicle 181 or 182 or the exit vehicle 18A, there are cases where the guidance route for the different autonomous driving vehicle 18 already exists. In this case, the guidance route for the different autonomous driving vehicle 18 is set as a non-overlapping route, and the management apparatus 39 avoids the non-overlapping route and calculates the guidance route for the obstructing vehicles 181 or 182 or the exit vehicle 18A.

Here, when there is the obstructing vehicle 181 or 182 or the exit vehicle 18A for which the guidance route is not able to be set, the management apparatus 39 repeats the process in S21 through processes in S22 and S31 described later. It should be noted that the management apparatus 39 may not be able to set a guidance route when trying to avoid the non-overlapping route. In this case, the management apparatus 39 shifts the process to S22 without setting the guidance route in S21.

Next, in S22, the management apparatus 39 determines whether the guidance routes for the autonomous driving vehicle 18 and the obstructing vehicle 181 or 182 selected as the obstructing vehicle are set. When the guidance route is not set, the management apparatus 39 waits for a preset predetermined time in S31. After that, the process returns to S21. Here, the management apparatus 39 may immediately reset the guidance route. However, in the present embodiment, the management apparatus 39 resets the guidance route after waiting for the predetermined time, in order to reduce the process load of the management apparatus 39.

When the guidance route is set in S22, the movement control unit 47E of the management apparatus 39 moves the selected obstructing vehicle 181 or 182 to the movement destination and moves the exit vehicle 18A along the guidance route in S23 and thereafter. That is, in S23, the movement control unit 47E transmits information representing the guidance route set in S21 (hereinafter referred to as guidance route information) with use of the communication unit 49. As described later, the autonomous driving vehicle 18 and the selected obstructing vehicle receive the guidance route information, and start autonomous driving along the guidance route.

The management apparatus 39 may adjust the timing of supplying the guidance route information to the autonomous driving vehicle 18. That is, the guidance route information may be transmitted to the obstructing vehicle 181 or 182 selected first, and then the guidance route information may be transmitted to the exit vehicle 18A.

Next, the management apparatus 39 acquires the position information of the autonomous driving vehicle 18 in S24. That is, the management apparatus 39 repeatedly receives the position information of each autonomous driving vehicles 18 until a parking completion notification is received.

Next, in S25, the management apparatus 39 releases a traveled route. That is, the management apparatus 39 identifies, based on the current positions of the autonomous driving vehicle 18 and the selected obstructing vehicle, an already traveled part of the aisle set to the guidance route in the parking lot for each of the autonomous driving vehicle 18 and the selected obstructing vehicle, and excludes the part from the guidance route. More specifically, the management apparatus 39 changes, in the map information, the setting of the already traveled part of the aisle for each of the autonomous driving vehicle 18 and the selected obstructing vehicle from the unavailable state to the available state. As the result, it may be possible to use, as the guidance route for the different autonomous driving vehicle 18, the parts where the autonomous driving vehicle 18 and the selected obstructing vehicle have already traveled.

Next, in S26, the management apparatus 39 determines whether the communication unit 49 has received a movement completion notification. The movement completion notification is a notification transmitted from the autonomous driving vehicle 18 when the autonomous driving vehicle 18 and the selected obstructing vehicle arrive at the target positions that are end positions of the guidance routes. When the communication unit 49 has received the movement completion notification, the present process ends. When the communication unit 49 has not received the movement completion notification, the process returns to S24.

[1-3. Effects]

The present embodiment can provide the following effects.

(1a) One aspect of the present disclosure provides the management apparatus 39 that assists in the automated valet parking of the vehicle. In the parking lot, multiple vehicles which can perform autonomous driving according to respective guidance routes set by the management apparatus 39 are referred to as autonomous driving vehicles 18. Among the multiple autonomous driving vehicles 18, a vehicle moving for the exit is referred to as the exit vehicle 18A. Further, vehicles that are parked autonomous driving vehicles 18 and obstruct the movement of the exit vehicle 18A are referred to as the obstructing vehicles 181 and 182.

The management apparatus 39 includes the load determination unit 47A, the movement destination setting unit 47D, and the movement control unit 47E. When receiving the exit request for causing the exit vehicle 18A to exit, the load determination unit 47A identifies the obstructing vehicles 181 and 182, and determines, for each of the obstructing vehicles 181 and 182, the movement load that is the magnitude of load caused by the movement for the parked exit vehicle 18A.

The movement destination setting unit 47D sets, to the movement destination, a non-obstruction position preset as a place that is less likely to obstruct the movement of the different exit vehicle as the movement loads of the obstructing vehicles 181 and 182 increase. The movement control unit 47E moves the obstructing vehicles 181 and 182 to the movement destinations, and moves the exit vehicle 18A along the guidance route.

According to such a configuration, when the obstructing vehicles 181 and 182 are moved, they are moved to the non-obstruction position. Therefore, it is possible to suppress situations in which the non-obstructing vehicles 181 and 182 have to be moved again when the different exit vehicle moves. Accordingly, it may be possible to prevent the same vehicle from frequently being moved.

(1b) In one aspect of the present disclosure, the management apparatus 39 further includes the movement determination unit 47B and the movement selection unit 47C. The load determination unit 47A identifies the obstructing vehicles 181 and 182 for each direction in which the exit vehicle 18A is able to move.

The movement determination unit 47B determines whether, in a case where the obstructing vehicles 181 or 182 is moved for each direction where the exit vehicle 18A is able to move, the exit vehicle 18A is able to move. In a case where there are multiple directions in which the exit vehicle 18A is able to move if the obstructing vehicles 181 and 182 are moved, the movement selection unit 47C selects the obstructing vehicle 181 or 182 positioned in a direction with the smaller movement load of the obstructing vehicle 181 or 182 among the directions in which the exit vehicle 18A is able to move.

The movement destination setting unit 47D sets the movement destination of the selected obstructing vehicles 181 or 182. The movement control unit 47E moves the selected obstructing vehicles 181 or 182 to the movement destination, and moves the exit vehicle 18A along the guidance route.

According to such a configuration, only the obstructing vehicle 181 or 182 positioned in the movement direction with the smaller parking load is moved when there are multiple directions in which the exit vehicle 18A is able to move. Therefore, it may be possible to cause the obstructing vehicle 181 or 182 with the bigger parking load to be less likely to move. Accordingly, it may be possible to prevent the same vehicle from frequently being moved.

(1c) According to one aspect of the present disclosure, the movement determination unit 47B determines whether there are multiple directions in which the exit vehicle 18A is able to move. In a case where there are multiple directions in which the exit vehicle 18A is able to move if the obstructing vehicle 181 or 182 is moved, the movement selection unit 47C compares a movement load of the obstructing vehicle 181 or 182 in a first movable direction with a movement load of the obstructing vehicle 181 or 182 in a second movable direction, and selects the obstructing vehicle 181 or 182.

According to such a configuration, it is possible to determine whether there are multiple movable directions. In other words, it is possible to determine whether the exit vehicle 18A is movable in multiple direction.

(1d) According to one aspect of the present disclosure, the movement destination setting unit 47D sets, as the movement destination for the selected obstructing 181 or 182, a position in the parking lot, the position being a position to which the obstructing vehicle 181 or 182 will not move until the exit request for the obstructing vehicle 181 or 182 is received.

According to such a configuration, it may be possible to eliminate the need to move the obstructing vehicle 181 or 182 having the bigger movement load.

(1e) According to one aspect of the present disclosure, the management apparatus 39 further includes the scheduling reception unit 47F. The scheduling reception unit 47F receives the exit scheduled time from the user who wishes the exit of the autonomous driving vehicle 18. The movement destination setting unit 47D sets the movement destination that is closer to the exit location as the exit scheduled time for the obstructing vehicle 181 or 182 is closer to a current time.

According to such a configuration, it may be possible to shorten the distance at the time of moving for the exit as the time difference between the current time and the exit scheduled time gets smaller.

(1f) According to one aspect of the present disclosure, the load determination unit 47A determines, as the movement load, the accumulated energy consumption that is the amount of energy consumed for the movement during the parking.

According to such a configuration, it may be possible to suppress the same vehicle from frequently being moved since the obstructing vehicles 181 or 182, which is moved according to the accumulated energy consumption, is able to be selected.

(1g) According to one aspect of the present disclosure, the load determination unit 47A determines, as the movement load, the fuel efficiencies of the obstructing vehicles 181 and 182. The movement selection unit 47C is difficult to select the obstructing vehicle 181 or 182 having the fuel efficiency that is less than the preset value.

According to such a configuration, it may be possible to set, according to the fuel efficiency, the obstructing vehicle 181 or 182 that is not moved as much as possible.

(1h) According to one aspect of the present disclosure, the load determination unit 47A determines, as the movement load, the degree of vehicle handling or the degree of automatic driving accuracy. The movement selection unit 47C becomes easier to select, from among the obstructing vehicles 181 and 182, the obstructing vehicle whose vehicle handling is equal to or higher than the preset reference or automatic driving accuracy is equal to or higher than the preset reference.

According to such a configuration, it may be possible to select a vehicle that is able to be handled well and make a small turn or a vehicle with the better accuracy of the autonomous driving, as the obstructing vehicles 181 and 182 to be moved. Therefore, it may be possible to safely move the obstructing vehicles 181 and 182 to narrower destinations. Accordingly, it may be possible to increase options of destinations of the obstructing vehicles 181 and 182.

(1i) According to one aspect of the present disclosure, the movement selection unit 47C makes the selection of the obstructing vehicle 181 or 182, which has the number of starts of the internal combustion engine less than the preset reference, easier by employing, as the movement load, the number of starts of the internal combustion engine.

According to such a configuration, an electric vehicle without the concept of starting the internal combustion engine or a vehicle in which the number of internal combustion engine starts is small is selected. Therefore, it may be possible to suppress the movement load from occurring only in a specific vehicle due to frequent starting of the internal combustion engine.

### 2. Other Embodiments

While the present disclosure has been described with reference to the embodiment thereof, it is to be understood that the disclosure is not limited to the embodiment and constructions. The present disclosure is intended to cover various modification and equivalent arrangements. In addition, while the various combinations and configurations, other combinations and configurations, including more, less or only a single element, are also within the spirit and scope of the present disclosure.

(2a) In the above embodiment, the movement destination of the movement vehicle is set based on two stages including the comparison of the score of the movement load with the first threshold and determination of whether the movement load is equal to higher than the first threshold. However, it is not limited to this. For example, the movement destination setting unit 47D may set the movement destination of the movement vehicle based on the multiple stages. In a case where the movement destination of the movement vehicle is set based on three stages, the movement destination setting unit 47D may set a place (for example, P2 or P4) that is less likely to obstruct the movement of the next different exit vehicle when the above score is equal to or higher than a second threshold set to be less than the first threshold and also the above score is less than the first threshold. Further, the movement destination setting unit 47D may set a different position (for example, P1 and P5) to the movement destination when the above score is less than the second threshold.

(2b) In the above embodiment, in S12, the load determination unit 47A may identify the obstructing vehicle as follows. That is, upon receiving the exit request, the load determination unit 47A refers to the map information to identify the position of the exit vehicle 18A. Then, based on the capturing image of the parking lot in the infrastructure 41, the load determination unit 47A determines whether the obstructing vehicles 181 and 182 are positioned in sections from current positions to the aisle for each of forward and backward directions of the exit vehicle 18A, and identifies the obstructing vehicles 181 and 182.

(2c) In the above embodiment, when the obstructing vehicles 181 and 182 are identified from the parked autonomous driving vehicles 18, the obstructing vehicles 181 and 182 positioned in the section to the aisle in the forward and backward directions of the exit vehicle 18A are identified. However, it is not limited to this. For example, the load determination unit 47A may identify an obstructing vehicle 181 or 182 in a section to the aisle in only the forward direction of the exit vehicle 18A.

In this case, in S13, it may be preferable that the load determination unit 47A determines whether there is the obstructing vehicle 181 or 182 in the forward direction of the exit vehicle 18A. Further, since it is assumed of only the forward direction of the exit vehicle 18A, S15 is omitted and it may be preferable that the process in this case may shift from S14 to S17. It should be noted that the movement destinations of the obstructing vehicles 181 and 182 may be determined according to the movement loads of the obstructing vehicles 181 and 182, as in the present embodiment.

(2d) In the above embodiment, the processes from S18 to S20 may be executed as follows.

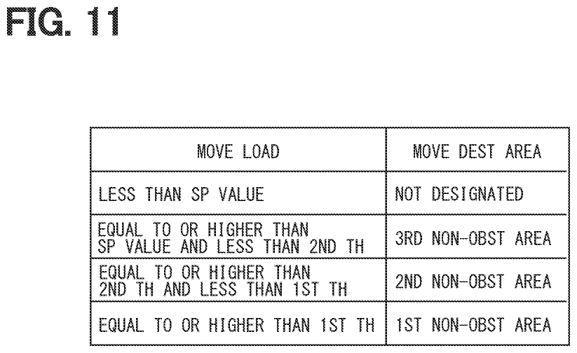

First, the movement destination setting unit 47D acquires the movement load of the obstructing vehicle 181 or 182 selected in S16 or S17. Next, the movement destination setting unit 47D determines the movement destination area based on the movement loads of the obstructing vehicles 181 and 182. For example, as shown in FIG. 11, the movement destination setting unit 47D may determine the movement destination areas of the obstructing vehicles 181 and 182 according to a correspondence relationship between the movement load and movement destination area. In the drawings, the specified value may be also referred to as “SP VALUE”, the first non-obstruction area may be also referred to as “1ST NON-OBST AREA”, the second non-obstruction area may be also referred to as “2ND NON-OBST AREA”, the third non-obstruction area may be also referred to as “3RD NON-OBST AREA”, and the term of “threshold” may be also referred to as “TH”.

Next, the movement destination setting unit 47D searches a vacant section in the determined movement destination area. When the movement load is less than the specified value, the movement destination setting unit 47D does not designate the movement destination area, and selects the closest vacant section from the current positions of the non-obstructing vehicles 181 and 182. When any of the first non-obstruction area 8A, the second non-obstruction area 8B, and the third non-obstruction area 8C is selected and also when there are multiple vacant sections, the closest vacant section from the current positions of the obstructing vehicles 181 and 182 in the selected area is selected. The processes after this process are the similar to those after S21.

(2e) The controller 47 and method described in the present disclosure may be implemented by a dedicated computer which is configured with a memory and a processor programmed to execute one or more particular functions embodied in computer programs of the memory. Alternatively, the controller 47 and the method according to the present disclosure may be implemented by a dedicated computer which is configured with a processor with one or more dedicated hardware logic circuits. Alternatively, the controller 47 and the method according to the present disclosure may be implemented using one or more dedicated computers which is configured by a combination of a processor and a memory programmed to execute one or more functions and a processor with one or more hardware logic circuits. Further, the computer program may be stored in a computer-readable non-transitory tangible storage medium as instructions to be executed by a computer. The technique for implementing the functions of each unit included in the controller 47 does not necessarily need to include software, and all the functions may be implemented using one or more hardware circuits.

(2f) The multiple functions of one component in the above embodiments may be implemented by multiple components, or a function of one component may be implemented by multiple components. Further, multiple functions of multiple elements may be implemented by one element, or one function implemented by multiple elements may be implemented by one element. A part of the configuration of the above embodiment may be omitted. Further, at least part of the configuration of the above-described embodiment may be added to or replaced with the configuration of another embodiment described above.

(2g) Other than the management apparatus 39 mentioned before, the present disclosure can also be implemented in various forms such as the system having the management apparatus 39 as a constituent element, a program for causing a computer to function as the management apparatus 39, a non-transitory tangible storage medium such as a semiconductor memory having the program stored thereon or an order setting method.

Here, the process of the flowchart or the flowchart described in this application includes a plurality of sections (or steps), and each section is expressed as, for example, S1. Further, each section may be divided into several subsections, while several sections may be combined into one section. Furthermore, each section thus configured may be referred to as a device, module, or means.

1. A parking assistance apparatus configured to assist in automated valet parking, wherein
in a parking lot, a plurality of vehicles each configured to perform autonomous driving along a guidance route set by the parking assistance apparatus are a plurality of autonomous vehicles, and
the plurality of autonomous vehicles include a plurality of exit vehicles each of which moves for an exit from a current position and an obstructing vehicle that obstructs at least one of the plurality of exit vehicles that is under the automated valet parking,
the parking assistance apparatus comprising:
a load determination unit configured to
identify the obstructing vehicle upon receiving an exit request for a particular exit vehicle that is one of the plurality of exit vehicles, and
determine a movement load of the obstructing vehicle, the movement load being a magnitude of a load necessary to move the obstructing vehicle so as not to obstruct the particular exit vehicle under the automated valet parking;
a movement destination setting unit configured to determine a non-obstruction position for the obstructing vehicle as a target parking position according to the movement load, wherein the obstructing vehicle is unlikely to obstruct an other exit vehicle of the plurality of exit vehicles when the obstructing vehicle is parked at the non-obstruction position; and
a movement controller configured to
move the obstructing vehicle to the non-obstruction position, and
move the particular exit vehicle along the guidance route.

2. The parking assistance apparatus according to claim 1, wherein
the obstructing vehicle are a plurality of obstructing vehicles positioned in a plurality of directions with respect to the particular exit vehicle,
the parking assistance apparatus further includes:
a movement determination unit configured to determine, for each direction, whether the particular exit vehicle is movable if the corresponding obstructing vehicle is moved; and
a movement selection unit configured to, when the particular exit vehicle would be moveable in a plurality of movable directions if the plurality of obstructing vehicles are moved, select one of the plurality of obstructing vehicles that has a minimum movement load,
the movement destination setting unit is further configured to set the non-obstruction position for the selected obstructing vehicle, and
the movement controller is configured to
move the selected obstructing vehicle to the non-obstruction position,
and move the particular exit vehicle along the guidance route.

3. The parking assistance apparatus according to claim 2, wherein
the plurality of obstructing vehicles include a first obstructing vehicle and a second obstructing vehicle, and
when the particular exit vehicle would be moveable in the plurality of movable directions if the first and second obstructing vehicles are moved, the movement selection unit is further configured to:
compare the movement load of the first obstructing vehicle with the movement load of the second obstructing vehicle; and
select one of the first obstructing vehicle and the second obstructing vehicle having a smaller movement load.

4. The parking assistance apparatus according to claim 2, wherein
the movement destination setting unit is configured to set, as the non-obstruction position of the obstructing vehicle, a position, in the parking lot, from which the obstructing vehicle will not move until the load determination unit receives an exit request for the obstructing vehicle.

5. The parking assistance apparatus according to claim 1, further comprising
a scheduling reception unit configured to receive an exit scheduled time input from each user,
wherein
the movement destination setting unit is configured to set a closer position to an exit place as the non-obstruction position as a time difference between the exit scheduled time for the obstructing vehicle and a current time gets smaller.

6. The parking assistance apparatus according to claim 5, wherein
the load determination unit is configured to determine, as the movement load, an accumulated energy consumption that is an accumulated amount of energy used to move the obstructing vehicle.

7. The parking assistance apparatus according to claim 5, wherein
the load determination unit is configured to determine, as the movement load, a fuel efficiency of the obstructing vehicle, and
the movement selection unit is configured to be less likely to select, as the obstructing vehicle, a vehicle having a fuel efficiency less than a preset value.

8. The parking assistance apparatus according to claim 5, wherein
the load determination unit is configured to determine, as the movement load, a degree of vehicle handling or a degree of an autonomous driving accuracy, and
the movement selection unit is configured to be more likely to select, as the obstructing vehicle, a vehicle having the vehicle handling equal to or higher than a preset reference or the autonomous driving accuracy equal to or higher than a preset reference.

9. The parking assistance apparatus according to claim 5, wherein
the movement load includes start times of an internal combustion engine, and
the movement selection unit is configured to be more likely to select, as the obstructing vehicle, a vehicle having the start times of the internal combustion engine less than a preset reference.

10. The parking assistance apparatus according to claim 1, further comprising
a processor that serves as the movement determination unit and the movement destination setting unit.

11. A parking assistance apparatus configured to assist in vehicle automated valet parking, wherein
in a parking lot, a plurality of vehicles each configured to perform autonomous driving along a guidance route set by the parking assistance apparatus are a plurality of autonomous vehicles, and
the plurality of autonomous vehicles include a plurality of exit vehicles each of which moves for an exit from a current position and an obstructing vehicle that obstructs at least one of the plurality of exit vehicles that is under the automated valet parking,
the parking assistance apparatus comprising:
a load determination unit configured to
identify the obstructing vehicle for each movable direction in which the exit vehicle is movable upon receiving an exit request for a particular exit vehicle that is one of the plurality of exit vehicles, and
determine a movement load of the obstructing vehicle, the movement load being a magnitude of a load necessary to move the obstructing vehicle so as not to obstruct the particular exit vehicle under the automated valet parking;
the parking assistance apparatus further includes:
a movement determination unit configured to determine, for each direction, whether the particular exit vehicle is movable if the corresponding obstructing vehicle is moved;
a movement selection unit configured to, when the particular exit vehicle would be moveable in a plurality of movable directions if the plurality of obstructing vehicles are moved, select one of the plurality of obstructing vehicles that has a minimum load;
a movement destination setting unit configured to set the non-obstruction position for the selected obstructing vehicle; and
a movement controller configured to
move the selected obstructing vehicle to the non-obstruction, and
move the particular exit vehicle along the guidance route.

12. The parking assistance apparatus according to claim 11, wherein
the load determination unit is configured to determine, as the movement load, an accumulated energy consumption that is an accumulated amount of energy used to move the obstructing vehicle.

13. The parking assistance apparatus according to claim 11, wherein
the load determination unit is configured to determine, as the movement load, a fuel efficiency of the obstructing vehicle, and
the movement selection unit is configured to be less likely to select, as the obstructing vehicle, a vehicle having a fuel efficiency less than a preset value.

14. The parking assistance apparatus according to claim 11, wherein
the load determination unit is configured to determine, as the movement load, a degree of vehicle handling or a degree of an autonomous driving accuracy, and
the movement selection unit is configured to be more likely to select, as the obstructing vehicle, a vehicle having the vehicle handling equal to or higher than a preset reference or the autonomous driving accuracy equal to or higher than a preset reference.

15. The parking assistance apparatus according to claim 11, wherein
the movement load includes start times of an internal combustion engine, and
the movement selection unit is configured to be more likely to select, as the obstructing vehicle, a vehicle having the start times of the internal combustion engine less than a preset reference.

16. The parking assistance apparatus according to claim 11, further comprising
a processor that serves as the load determination unit, the movement determination unit, the movement selection unit, and the movement destination setting unit.

17. A parking assistance method performed by a parking assistance apparatus configured to assist in vehicle automated valet parking, wherein
in a parking lot, a plurality of vehicles each configured to perform autonomous driving along a guidance route set by the parking assistance apparatus are a plurality of autonomous vehicles, and
the plurality of autonomous vehicles include a plurality of exit vehicles each of which moves for an exit from a current position and an obstructing vehicle that obstructs at least one of the exit vehicles that is under the automated valet parking,
the parking assistance method comprising:
identifying the obstructing vehicle upon receiving an exit request for a particular exit vehicle that is one of the plurality of exit vehicles;
determining a movement load of the obstructing vehicle, the movement load being a magnitude of a load necessary to move the obstructing vehicle so as not to obstruct the particular exit vehicle under the automated valet parking;
determining a non-obstruction position for the obstructing vehicle as a target parking position according to the movement load, wherein the obstructing vehicle is unlikely to obstruct an other exit vehicle of the plurality of exit vehicles when the obstructing vehicle is parked at the non-obstruction position;
moving the obstructing vehicle to the non-obstruction position; and
moving the particular exit vehicle along the guidance route.

18. A non-transitory tangible storage medium storing a parking assistance program executed by a computer of a parking assistance apparatus that is configured to assist in vehicle automated valet parking, wherein
in a parking lot, a plurality of vehicles each configured to perform autonomous driving along a guidance route set by the parking assistance apparatus are a plurality of autonomous vehicles, and
the plurality of autonomous vehicles include a plurality of exit vehicles each of which moves for an exit from a current position and an obstructing vehicle that obstructs at least one of the exit vehicles that is under the automated valet parking,
the program comprising instructions, when executed by the computer, causing the computer to:
identify the obstructing vehicle upon receiving an exit request for a particular exit vehicle that is one of the plurality of exit vehicles;
determine a movement load of the obstructing vehicle, the movement load being a magnitude of a load necessary to move the obstructing vehicle so as not to obstruct the particular exit vehicle under the automated valet parking;
determine a non-obstruction position for the obstructing vehicle as a target parking position according to the movement load, wherein the obstructing vehicle is unlikely to obstruct an other exit vehicle of the plurality of exit vehicles when the obstructing vehicle is parked at the non-obstruction position;
move the obstructing vehicle to the non-obstruction position; and
move the particular exit vehicle along the guidance route.
